(19) United States
(12) Patent Application Publication
(10) Pub. No.: US 2009/0081042 A1
(43) Pub. Date: Mar. 26, 2009

(54) METHOD OF CONTROLLING A WINDMILL, ESPECIALLY IN STAND-ALONE OPERATION AND A WINDMILL

(76) Inventor: Arne Johansen, Roskilde (DK)

Correspondence Address: BROWDY AND NEIMARK, P.L.L.C.;624 NINTH STREET, NW, SUITE 300, WASHINGTON, DC, 20001-5303, US

(21) Appl. No.: 10/593,319

(22) PCT Filed: Mar. 17, 2005
(86) PCT No.: PCT/DK2005/000181

§ 371 Date: Nov. 10, 2008

(30) Foreign Application Priority Data
Mar. 17, 2004 (DK) PA 2004 00429

(51) Int. Cl. F03D 7/00

(52) U.S. Cl. 416/44; 416/1

(57) ABSTRACT

A windmill comprising a rotor having a substantially horizontal axis of rotation (1a) and at least two blades (4) extending along a respective blade axis, about which the blade can be rotated to an adjustment angle for the blade, and a blade adjusting device (11, 13) for adjusting a common basic angle of adjustment for the blades (4), said windmill further comprising means (14) for detecting the size of the basic angle of adjustment, means for detecting the load on the windmill and means (15-22) for detecting the deflection of the blade, preferably in the direction of the axis of the rotor (1a), is controlled according to the invention by adjustment of the basic angle of adjustment, a control signal for the blade adjusting device being provided in dependency of the load and the wind speed, and, as a measure for the wind speed, the deflection (α) of the blade is used, preferably in the direction of the rotational axis (1a) of the rotor.

The invention generally relates to windmills producing electrical power.

The invention relates to a method of controlling a windmill, especially in stand-alone operation, said windmill comprising a rotor having a substantially horizontal axis of rotation, at least two blades, which are each at one end connected with the rotor and extending from there substantially along a blade axis, about which the blade can be rotated to an adjustment angle for the blade, a blade adjusting device for adjusting a common basic angle of adjustment for the blades, means for detecting the size of the basic angle of adjustment, means for detecting the load on the windmill, means for detecting the deflection of the blade in the direction of the axis of rotation, in which method the rotational speed of the windmill rotor is controlled by adjustment of the basic angle of adjustment, a control signal for the blade adjusting device being provided in dependency of the load and the wind speed.

The invention further relates to a windmill comprising a rotor having a substantially horizontal axis of rotation, at least two blades, which are each at one end connected with the rotor and extending from there substantially along a blade axis, about which the blade can be rotated through a first bearing to an adjustment angle for the blade, a blade adjusting device for adjusting a common basic angle of adjustment for the blades, a hinge between the blade and the rotor with a hinge axis extending in a direction transversely to the blade axis and the direction of the axis of rotation of the rotor, whereby the blades can each be deflected in the direction of the axis of rotation of the rotor by rotation about the respective hinge axis. A windmill of this kind is known from Applicant's own DK-B-174 346.

An example of a method of the above kind for controlling a windmill is disclosed in GB-A-2 023 237. According to this publication the wind speed is measured by means of a wind measuring device, which is positioned on the gondola of the windmill or at a place, where it is not influenced by the rotation of the wind turbine.

U.S. Pat. No. 6,619,918 describes a windmill, which among others is provided with strain gauges on the blades with a view to monitoring the deflection of the blades in order to prevent collision with the mill tower. With an appropriate positioning of the strain gauges such a windmill could be used for carrying out the method according to the invention.

Other examples of prior art are disclosed in:

U.S. Pat. No. 6,361,275, which aims at reducing (peak) loads on the components of a mill. To that end tensions of various components, for instance the blades, are measured by means of strain gauges; a desired angle position of each individual blade is determined independent on the other blades, and an adjusting device places the respective blades in the desired positions in order to prevent peak loads and to extend the useful life of the mill. Also wind vanes or wind indicators mounted on the blades are used for measuring the angle of attack of the wind.

U.S. Pat. No. 4,183,715 discloses a windmill with blades turning up against the wind as a consequence of an aerodynamic lift. A plumb or a servomotor counteracts the turning in order to control the mill. In the embodiment with the servo motor the wind speed measured by a wind measuring device on the mill casing may be included in the controlling.

U.S. Pat. No. 4,297,076 discloses a windmill with strain gauges for monitoring the load on the blades. The signals from these strain gauges are used for determining, whether the mill is facing the wind and, if needed, to provide a signal to a head turning motor. Furthermore, the signals of the strain gauges are used to adjust the angles of the blade tips of the mill to prevent continued overloading and oscillatory stress of the hub of the mill. The control system of the mill comprises a closed control loop based on the number of revolutions and an open control loop based on the output, which is delivered by the mill to the network, to which it is connected, and the wind speed measured by a wind measuring device. The precise direction of the measuring by the strain gauges of the load on the blades does not appear from the publication. However, the strain gauges seem to be positioned in the centre of the profiled portion of the blades somewhat away from the root of the blade, such that the strain gauges will measure in a direction perpendicular to the blade profile, which is pitched relative to a plane perpendicular to the axis of rotation of the rotor. In this manner the strain gauges will measure in directions, which are not in parallel with the rotational direction of the rotor.

DD-A-252 640 describes a windmill, which by means of a system for controlling the angle of adjustment of the blades aims at utilizing the wind energy optimally, maintaining a certain number of revolutions and avoiding overloading. Therefore, a bending moment acting on the root of the blade is measured, and a signal proportional to the bending moment is processed in dependency on a signal from a device controlling the number of revolutions to a control impulse to a motor adjusting the blades. Measuring of the output of the mill is not mentioned, and the bending moment seems to be measured in a direction of approximately 45° from the direction of the rotational axis of the rotor.

In stand-alone operation of a mill, i.e. operation of a mill, which is not connected to a network with a frequency, which can be used to control the mill, it is difficult to control the rotational speed of the mill precisely, such that through an alternating current generator an alternating current can be achieved at a substantially constant frequency. This problem is among others mentioned in the above GB-A-2 023 237, which describes a method of controlling a windmill.

A prerequisite for a precise control of a windmill is, however, an accurate and reliable measurement of the wind load on the mill, as it is this load, which by the mill blades is converted into rotational energy, which can further be converted into electrical power in a generator.

The object of the invention is according to one aspect to provide a method for controlling a windmill, whereby the rotational speed of the mill and thus the frequency of an alternating current produced by an associated generator can be kept constant within narrow tolerances.

The object is according to a second aspect to provide a windmill, which can be used for carrying out the method.

The object is met according to the first aspect by a method of the type mentioned by way of introduction, which is characterized in that as a measure for the wind speed the deflection of the blade in the direction of the rotational axis of the rotor is used.

The object is met according to the second aspect of a windmill of the above type, which is characterized in comprising a device for detecting the size of the deflection of a blade in the direction of the rotational axis of the rotor and means for detecting the size of the basic angle of adjustment and means for transferring a detected size of the blade deflection and a detected size of the basic angle of adjustment to a control device.

The invention is based on the realization that because wind is an unstable parameter with turbulence and gusts of wind, such that the wind load may vary considerably within a distance of a few meters, the blades of the windmill are to be used as wind gauges, if an accurate measure for the wind load on the mill is to be obtained. Consequently, the blades of the mill are according to the invention used as a wind gauge for providing an input signal to the control unit of the mill.

An accurate measure of the wind load, and in particular the changes thereof, is necessary for the controlling of a mill with a quick response, which is a prerequisite for an accurate control.

In preferred embodiments of the method according to the invention the rotational speed of the rotor is measured and the measured value is used for generating the control signal for the blade adjusting device.

In a practical embodiment the deflection of the blade having the greatest deflection is used as a measure for the wind speed.

By using the rotational speed of the rotor in the controlling, a closed control loop can be established to ensure that the rotational speed does not float relative to the desired value.

If only the rotational speed is used for controlling, a control response is not established until the rotational speed has changed.

By using the actual wind load on the mill blades a control response can be established, when the wind load changes, before this change has resulted in a change of the rotational speed.

In a practical embodiment of the windmill according to the invention a device for detecting the deflection of the blade having the greatest deflection is provided. Furthermore, means are provided for detecting the rotational speed of the rotor and means for transferring the detected value to a control unit.

A control unit for providing a control signal to the blade adjusting device may be a part of the mill. Alternatively, an external control unit may be connected with the mill. The control unit will in practice comprise a computer.

The method of controlling according to the invention is primarily intended for controlling a windmill in stand-alone operation, where the power supplied by the mill is to meet the demand, as there will be no other sources of control. The method may, however, also be used on a windmill in a network, where the method may be used for providing a substantially constant output power from the windmill, such that the control of the network is generally facilitated.

When used in stand-alone operation, a windmill according to the invention may be provided with an asynchronous generator with extra windings, which provides magnetizing current to the stator winding of the generator. Such generators constitute prior art, and it is possible to control them by controlling the strength of the magnetizing current created on account of the extra windings, which is supplied to the stator winding of the generator. It is thus possible to control the load or the output power of the generator. By use of such a generator, it is for instance possible, if the power can be allowed to vary up to a given maximum, to control the magnetizing current and thus the output power of the generator at increasing wind speed, until said maximum has been reached, and first then to control the basic angle of adjustment of the blades in order not to exceed this maximum of the output power and vice versa.

The invention will be explained in detail in the following by means of examples of embodiments with reference to the schematic drawing, in which

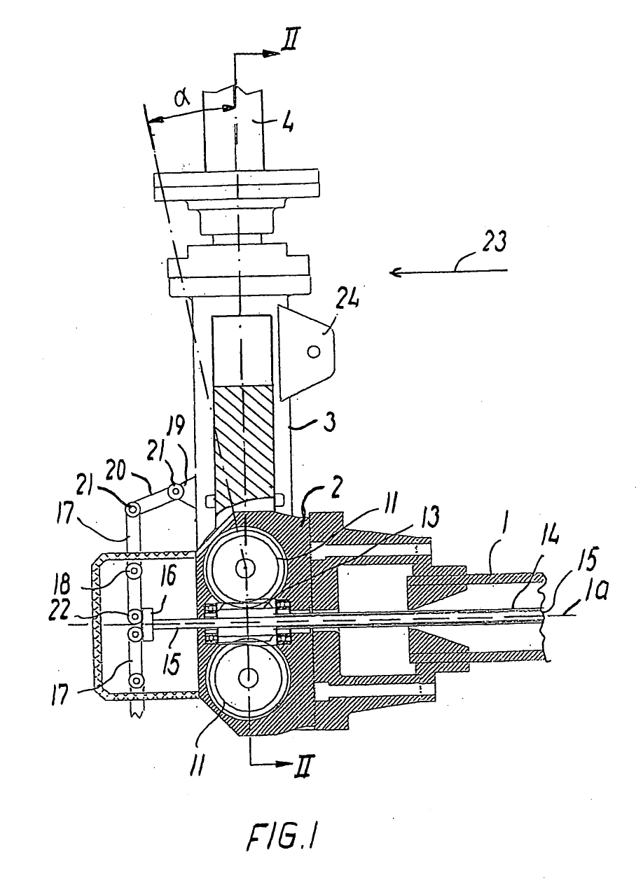

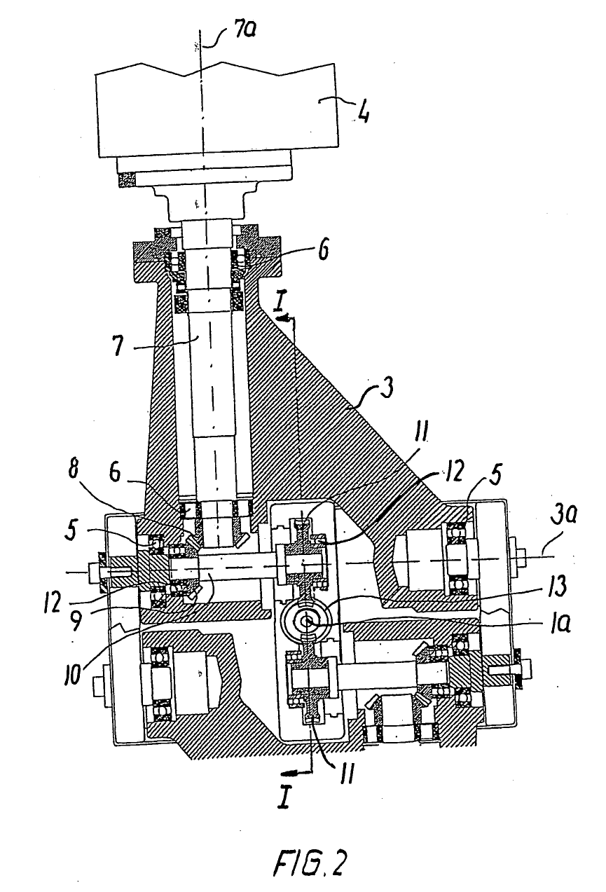

FIG. 1 is a sectional view along the main axis of a rotor casing of a windmill as indicated by I-I in FIG. 2,

FIG. 2 is a sectional view as indicated by II-II in FIG. 1, and

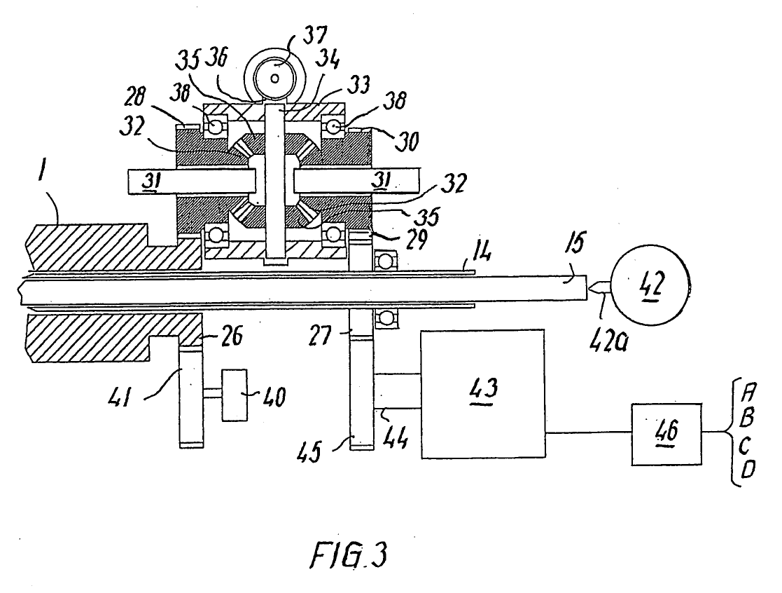

FIG. 3 is a sectional view along the main axis through the controlling part.

With reference to FIGS. 1 and 2 a windmill according to the invention has a main shaft 1, extending along and rotatable about a main axis 1a. The main shaft 1 extends into the gondola of the mill (not shown) to a gear for transmission of rotational energy to an alternating current generator in a manner known per se.

The main shaft 1 is in a torque-proof manner connected with and carries a rotor casing 2, which carries two bearing housings 3, which each carries a blade 4. The rotor casing 2 and its arrangement and equipment are symmetrical about the main axis la. Therefore, only one blade 4 and its fastening to the rotor casing 2 will be described in the following.

The mill described here with reference to the drawings is provided with two blades, but the person skilled in the art will understand that the invention can be used in connection with mills having more, for instance three, blades. Furthermore, the mill described with reference to the drawings is a so-called downwind rotor, i.e. that the rotor with the blades is positioned on the lee side of the mill tower not shown. The person skilled in the art will realize that the invention can also be used on a forerunner, i.e. a mill, the rotor and the blades of which are situated on the windward side of the mill tower.

The bearing housing 3 is by means of two bearings 5 hinged to the rotor casing 2 in such a manner that the bearing housing 3 may pivot about an axis 3a extending in a plane perpendicular to the main axis la.

In the bearing housing 3 a blade root 7 is journalled through two bearings 6, said blade root being thus rotatable about a blade axis 7a. The blade root 7 carries at one end the blade 4 and is at the other end connected in a torque-proof manner with a bevel gear 8, which is in engagement with a second bevel gear 9. The second bevel gear 9 is fastened to an adjusting shaft 10, which carries a worm wheel 11. The adjusting shaft 10 with the bevel gear 9 and the worm wheel 11 are through bearings 12 journalled rotatably about the axis 3a in the bearing housing 3.

The worm wheel 11 is in engagement with a worm 13, which can be rotated by means of a hollow control shaft 14 extending coaxially through the main shaft 1.

A strut 15, which at the end shown in FIG. 1 carries an abutting plate 16, extends through the hollow control shaft 14. A lever arm 17 is able to tilt about a bearing 18 and is at one end connected with the bearing housing 3 through a console 19 on the bearing housing 3 and a joint 20, which through hinges 21 is connected with the console 19 and the lever arm 17. At the end opposite the joint 20 the lever arm carries a pressure roller 22, which may abut against the abutting plate 16.

In operation of the mill, the centrifugal force will tend to position the blade 4 with the blade axis 4a perpendicular to the main axis, whereas the pressure from the wind, as indicated by an arrow 23 in FIG. 1, will try to press the blade backwards about the axis 3a to a deflection angle α. When not in operation the gravity will rotate one blade downwards about the axis 3a. Therefore, the rotor casing 2 preferably carries stabilizing springs (not shown), which tend to keep the blades 4 perpendicularly to the main axis la. Such a stabilizing spring may be fastened to a console 24 on each bearing housing 3.

It is appreciated that by rotation of the blade 4 about the axis 3a, the bevel gear 8 of the blade root 7 will roll on the bevel gear 9 of the adjusting shaft 10, whereby the blade 7 will rotate correspondingly about the blade axis 7a. This rotation does not influence the second blade not shown.

Moreover, it is appreciated that rotation of the worm 13 by means of the control shaft 14 will result in a rotation of the adjusting shaft 10 and consequently a rotation of the blade 4. This rotation applies to both blades, both the one shown and the one not shown.

In FIG. 3 the control part of the mill is shown. Thus FIG. 3 shows the end, which is opposite to the one shown in FIG. 1, of the main shaft 1, the control shaft 14 and the strut 15.

The main shaft 1 carries in a torque-proof manner a first spur gear 26, and the control shaft 14 carries in a torque-proof manner a second spur gear 27. The first spur gear 26 is in engagement with a third spur gear 28, and the second spur gear 27 is through an intermediate wheel 29 in engagement with a fourth spur gear 30. The third and the fourth spur gears 28 and 30 are carried rotatably by shafts 31, which are fixedly mounted in the gondola of the windmill not shown, and which are fixedly connected with each respective of two first, opposite, bevel gears 32 in a differential having a differential housing 33 rotatable through bearings 38. Rotatably about a differential shaft 34 two other, opposite, bevel gears 35 are provided, said spur gears being in engagement with the first, opposite, bevel gears 32. The differential housing 33 carries on its peripheral surface a worm wheel 36, which is in engagement with a worm 37 fixedly mounted in the gondola, said worm 37 being rotatable about an axis perpendicular to the plane of the drawing.

The first and the third spur gears 26 and 28 have the same diameter, and the second and the fourth spur gear 27 and 30 have the same diameter. As a consequence, the differential shaft 34 will be at a standstill, when the main shaft 1 and the control shaft 14 have the same rotational speed and direction. If the main shaft 1 and the control shaft 15 do not have the same rotational speed and direction, the differential shaft 34 will rotate about an axis coaxial with the shafts 31 bringing along the differential housing 33 and the worm wheel 36. The latter will on account of its engagement drive the worm 37.

If the main shaft 1 and the control shaft 14 rotate at different speeds, the result will be a turning of the worm 13 in the rotor casing 2 and consequently a turning of the blades. Consequently, it is possible through the worm 37 to output a basic angle of adjustment of the blades.

A revolution counter 40 is through a fifth spur gear 41 in engagement with a first spur gear 26 connected with the main shaft and thus indicates its rotational speed.

A position reader 42 is provided with a key 42a in abutment against the end of the strut 15 and therefore provides through the lever arm 17 a measure of the deflection angle α for the blade having the highest deflection angle.

A control motor 43 carries on its shaft 44 a fixedly positioned sixth spur gear 45, which is in engagement with the second spur gear 27. Thereby, the control motor 43 controls the rotation of the control shaft 14.

The control motor 43 is controlled by a microprocessor, which is provided with a control device 46 receiving signals from the worm 37, the revolution counter 40, the position reader 42 and, moreover, a signal indicating the load on the mill, for instance by an indication of the power delivered by the generator not shown.

The generator is an asynchronous machine with an extra stator winding, in which a number of permanent magnets is included, i.e. the magnetizing is performed by means of permanent magnets and electro magnets. The generator also has an additional rotor winding, in which, from the extra stator winding, a magnetizing potential is induced for supplying the original rotor winding, which is superposed.

The control device 46 receives in a preferred embodiment the following signals:

A: a measure of the basic angle of adjustment of the blades derived from the worm 37,

B: a measure of the rotational speed of the windmill (of the main shaft 1) derived from the revolution reader 40,

C: a measure of the wind speed against the mill blades or wind load on the mill blades expressed by the deflection angle α derived from the position reader 42, and

D: a measure of the power of the mill as delivered by the generator (the voltage and the power of the generator).

In the embodiment described here, the windmill is a stand-alone operation, i.e. it is not connected to a major network. The rotational speed of the mill is, as far as possible, to be kept constant, as the frequency of the current supplied by the generator is proportional with the rotational speed of the mill, and it is desirable to keep this frequency as constant as possible.

In operation, the power of the mill is to be varied in accordance with the demand, as excess power from the mill will be received as kinetic energy in the rotating parts of the mill, i.e. the rotational speed of the mill will increase, which, as mentioned, is undesirable.

At constant wind load, the power may be adjusted by adjusting the basic angle of adjustment of the blades.

On account of the fact that the wind load and the power demand in reality vary at random, the control motor 43 of the control device 46 is controlled in an open control loop, in which the control device determines a desired basic angle of adjustment on basis of the measures C and D in respect of the wind load and the power collected.

As a starting point, the control shaft 14 is rotated at the same rotational speed as the main shaft 1. If a change of the basic angle of adjustment of the blades is required, the rotational speed of the control shaft is increased or reduced. The change of the basic angle of adjustment is derived as the measure A from the worm 37. When the measure A corresponds to the one set by the control device 46, the speed of the control shaft 14 is adjusted to the rotational speed of the main shaft 1 desired.

To prevent the rotational speed of the main shaft 1 from floating, the open control loop is superimposed by a closed control loop with feedback of the measure D from the revolution reader to the control device 46.

Tests have shown that in this manner an alternating current from the generator may be achieved at a frequency, which only deviates +/−2.5% from what is desirable.

The individual blades will, in addition to the basic adjusting angle, change their actual adjusting angle as a consequence of their actual deflection angle α in the same manner as described in Applicant's above-mentioned, prior Danish Patent No. 174 346.

1. A method of controlling a windmill, especially in stand-alone operation,
said windmill comprising a rotor having a substantially horizontal axis of rotation, at least two blades, which are each at one end connected with the rotor and extending from there substantially along a blade axis, about which the blade can be rotated to an adjustment angle for the blade, a blade adjusting device for adjusting a common basic angle of adjustment for the blades, means for detecting the size of the basic angle of adjustment, means for detecting the load on the windmill, means for detecting the deflection of the blade in the direction of the axis of rotation,
in which method the rotational speed of the windmill rotor is controlled by adjustment of the basic angle of adjustment, a control signal for the blade adjusting device being provided in dependency of the load and the wind speed, whereby the deflection of the blade in the direction of the axis of rotation is used as a measure for the wind speed.

2. A method according to claim 1, wherein the rotational speed of the rotor is measured and used for the provision of the control signal for the blade adjusting device.

3. A method according to claim 1, wherein as a measure for the wind speed the deflection of the blade having the greatest deflection is used.

4. A windmill comprising
a rotor having a substantially horizontal axis of rotation,
at least two wings, which are each at one end connected with the rotor and extending from there substantially along a blade axis, about which the blade can be rotated,
a first bearing for an adjustment angle for the blade,
a blade adjusting device for adjusting a common basic adjustment angle for the blades,
a hinge between the blade and the rotor with a hinge axis extending in a direction transversely to the blade axis and the direction of the axis of rotation of the rotor, whereby the blades can each be deflected in the direction of the axis of rotation of the rotor by rotation about the respective hinge axis, and comprising a device for detecting the size of the deflection of a blade in the direction of the axis of rotation of the rotor and means for detecting the size of the basic angle of adjustment and means for transferring a detected size of a blade deflection and a detected size of the basic angle of adjustment to a controlling device.

5. A windmill according to claim 4, comprising a device for detecting the deflection of the blade having the greatest deflection.

6. A windmill according to claim 4, comprising means for detecting the rotational speed of the rotor and means for transferring the detected value to a control unit.

7. A windmill according to claim 4, comprising a control unit for providing a control signal to the blade adjusting device.
